(19) United States
(12) Patent Application Publication
(10) Pub. No.: US 2025/0306363 A1
(43) Pub. Date: Oct. 2, 2025

(54) AUGMENTED REALITY DISPLAY APPARATUS AND CHROMATIC ABERRATION ADJUSTMENT METHOD

(71) Applicant: Interface Advanced Technology (Chengdu) Co., Ltd., Chengdu (CN)

(72) Inventors: JING WANG, Chengdu (CN); JUN HUANG, Chengdu (CN)

(21) Appl. No.: 18/705,482

(22) PCT Filed: Jan. 2, 2024
(86) PCT No.: PCT/CN2024/070077

§ 371 Date: Apr. 26, 2024

(30) Foreign Application Priority Data
Oct. 17, 2023 (CN) 202311356188.9

(51) Int. Cl. G02B 27/01; G02B 26/08

(52) U.S. Cl. CPC G02B 27/0101; G02B 26/0816; G02B 2027/0116

(57) ABSTRACT

An augmented reality display apparatus includes a display device for emitting image light, an optical waveguide including a plurality of modulation portions, and a control device connected to the plurality of modulation portions. Each of the plurality of modulation portions is configured to receive and reflect the image light, the optical waveguide is configured to receive and guide the image light to human eye. The control device is configured to provide a power voltage to each of the plurality of modulation portions. A deformation degree of each of the plurality of modulation portions changes with a value of the power voltage, and the control device is further configured to control a direction of the image light by controlling the deformation degree of the plurality of modulation portions. A chromatic aberration adjustment method is also provided.

### CROSS-REFERENCE TO RELATED DISCLOSURES

This disclosure claims the benefit of priority of Chinese Disclosure No. 202311356188.9 filed on Oct. 17, 2023 and titled “AUGMENTED REALITY DISPLAY APPARATUS AND CHROMATIC ABERRATION ADJUSTMENT METHOD,” the contents of which are incorporated by reference herein.

### FIELD

The subject matter herein generally relates to augmented reality technology, and particularly relates to an augmented reality display apparatus and a chromatic aberration adjustment method.

### BACKGROUND

Augmented Reality (AR) technology is applied to entertainment electronic products, such as AR display devices such as AR glasses. Waveguide technology has emerged with a demand for the AR display devices and has advantages of small size and high penetration characteristics. However, in existing AR display devices using waveguide, image light emitted by a display device in the AR display devices includes multiple primary lights of different wavelength, and reflection paths of the primary lights in the waveguide will be different even if the primary lights enter the waveguide at a same point, which causes chromatic aberration in a display image of the AR display device.

Conventional chromatic aberration adjustment methods cannot finely correct chromatic aberration of AR display devices with different structure. A conventional chromatic aberration adjustment method is making special treatment of a total reflective coating in a total reflection area of the waveguide, which cannot solve a problem of chromatic aberration caused by different AR display devices having quality differences.

### SUMMARY

A first aspect of the present disclosure provides an augment reality display apparatus including: a display device for emitting image light; an optical waveguide comprising a plurality of modulation portions, each of the plurality of modulation portions being configured to receive and reflect the image light, the optical waveguide being configured to receive and guide the image light to human eye; and a control device electrically connected to the plurality of modulation portions and being configured to provide a power voltage to each of the plurality of modulation portions; wherein a deformation degree of each of the plurality of modulation portions changes with a value of the power voltage, and the control device is further configured to control a direction of the image light by controlling the deformation degree of the plurality of modulation portions.

The augmented reality display apparatus provided in the present disclosure changes a deformation degree of the modulation portion by changing a value of the power voltage applied to the modulation portion, thereby changing a reflection direction of the image light, which can solve a chromatic aberration problem caused by different primary lights of the augmented reality display apparatus. This disclosure can solve difference problem caused by different primary lights, and can also perform chromatic aberration correction on different display device.

In one embodiment, the display device comprises a plurality of pixels, each of the plurality of pixels comprises a plurality of sub-pixels to emit a plurality of primary lights of different colors simultaneously; and the plurality of sub-pixels corresponds to the plurality of modulation portions one-by-one, each of the plurality of modulation portions is configured to change one of the plurality of primary lights from a corresponding sub-pixel, the control device is configured to control the directions of the plurality of primary lights simultaneously.

In one embodiment, the display device comprises a plurality of pixels, each of the plurality of pixels comprises a plurality of sub-pixels to emit a plurality of primary lights of different colors successively; and the plurality of pixels corresponds to the plurality of modulation portions one-by-one, each of the plurality of modulation portions is configured to change one of the plurality of primary lights from a corresponding pixel, the control device is configured to control the directions of the plurality of primary lights successively.

In one embodiment, each of the plurality of modulation portions comprises a piezoelectric ceramic and a reflecting layer on a surface of the piezoelectric ceramic facing the display device.

In one embodiment, the reflecting layer is configured to reflect the image light, the piezoelectric ceramic is connected to the control device, and the control device is further configured to change the deformation degree of the piezoelectric ceramic by changing the value of the power voltage.

In one embodiment, the optical waveguide comprises a total reflex portion configured for total reflection of the image light from the plurality of modulation portions.

In one embodiment, wherein the waveguide further comprises an outgoing diffraction portion configured to receive and reflect the image light after been total reflected by the total reflex portion, and the image light exit from the outgoing diffraction portion forms image to the human eye.

A second aspect of the present disclosure provides a chromatic aberration adjustment method configured to correct a chromatic aberration of an image and applied to an augmented reality display device, comprising: obtaining image light from an optical waveguide; determining if an image formed by the image light has a chromatic aberration; if there is a chromatic aberration, calculating a light deflection angle, adjusting a value of a power voltage applied to the modulation portion based on the light deflection angle to change a reflection direction of the image light, obtaining an adjusted image, and determining if the adjusted image has a chromatic aberration; and if there is no chromatic aberration, storing the value of the power voltage applied to a plurality of modulation portions.

In one embodiment, the obtaining image light from an optical waveguide comprises: obtaining the image light by a color analyzer and saving a position information of each of a plurality of pixels of a display device.

In one embodiment, the determining if an image formed by the image light has a chromatic aberration comprises: determining whether a deviation is between a position of each of the plurality of pixels in the image and the position of each of the plurality of pixels in the display device.

The chromatic aberration adjustment method is applied to the augmented reality display device, and has the same advantages as the augment reality display apparatus described above.

### BRIEF DESCRIPTION OF THE DRAWINGS

FIG. 1 shows an augmented reality display apparatus according to an embodiment of the present disclosure.

FIG. 2 shows a piezoelectric ceramic according to an embodiment of the present disclosure.

FIG. 3 is a schematic view of a corresponding relationship between a pixel and a modulation portion according to an embodiment of the present disclosure.

FIG. 4 is a schematic view of a corresponding relationship between a pixel and a modulation portion according to another embodiment of the present disclosure.

FIG. 5 is a schematic view of an image displayed by a 2×2 pixel array of a display device ((a) in FIG. 5 is a schematic view of a preset image displayed by a 2×2 pixel array, (b) in FIG. 5 is a schematic view of an actual image displayed by the 2×2 pixel array, and (c) in FIG. 5 is a schematic view of calculating a deviation angle).

FIG. 6 is a schematic view of an image light incidents on the modulation portion according to an embodiment of the present disclosure.

FIG. 7 shows an optical waveguide according to an embodiment of the present disclosure.

FIG. 8 is a flow chart of a chromatic aberration adjustment method according to an embodiment of the present disclosure.

DESCRIPTION OF SYMBOLS OF MAIN COMPONENTS

| | |
|---|---|
| Augment reality display apparatus | 100 |
| Display device | 1 |
| pixel | 10 |
| Sub-pixel | 11 |
| Primary light | L0 |
| Optical waveguide | 2 |
| Modulation portion | 20 |
| Piezoelectric ceramics | 21 |
| Reflecting layer | 210 |
| Total reflex part | 23 |
| First medium | n1 |
| Second medium | n2 |
| Outgoing diffraction portion | 25 |
| Exit coupled grating | 251 |
| Deformation degree | ΔL |
| Control device | 3 |
| Color analyzer | 4 |
| Power voltage | V |
| Image light | L1 |
| Deflection angle | θ |
| Incident angle | α |
| Diffraction angle | β |
| Initial incident angle | γ |
| First direction | X |
| Second direction | Y |
| Block | S1, S2, S3, S4 |

The following specific embodiments will further illustrate the present disclosure in conjunction with the above drawings.

### DETAILED DESCRIPTION

The following will provide a clear and complete description of the technical solution in the embodiments of this disclosure, in conjunction with the accompanying drawings. Obviously, the described embodiments are only a part of the embodiments of this disclosure, not all of them.

Unless otherwise defined, all technical and scientific terms used in this disclosure have the same meanings as those commonly understood by those skilled in the technical field of this disclosure. The terms used in the specification of this disclosure are only for the purpose of describing specific embodiments and are not intended to limit this disclosure.

In order to further elaborate on the technical means and effects adopted to achieve the intended purpose of this disclosure, the following is a detailed explanation of this disclosure, combined with the accompanying drawings and preferred implementation methods.

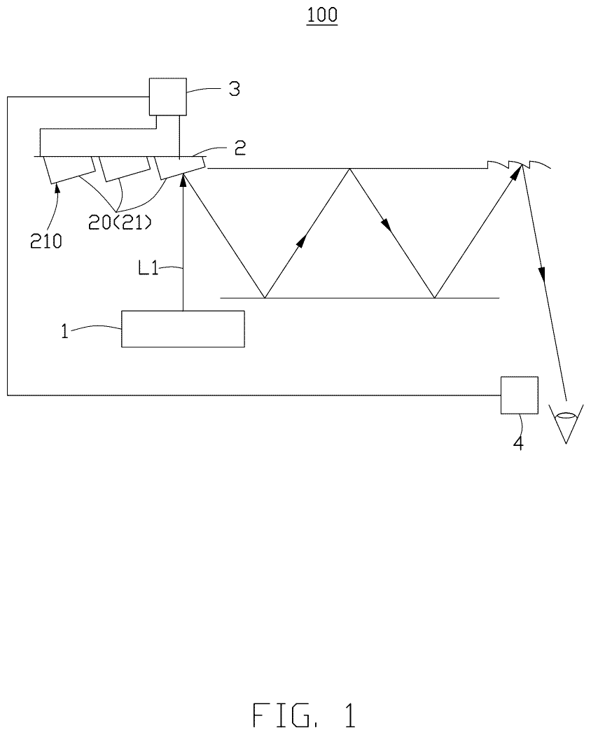

As shown in FIG. 1, an augmented reality display apparatus 100 of an embodiment includes a display device 1, an optical waveguide 2, and a control device 3. The display device 1 is used to emit image light L1. The optical waveguide 2 includes a plurality of modulation portions 20 with similar structures and used to receive and reflect the image light L1. The optical waveguide 2 is used to guide the image light L1 to human eye. The control device 3 is connected to the modulation portions 20 and is used to apply a power voltage to each of the modulation portions 20. A deformation degree of each of the modulation portion 20 changes with a value of the power voltage, and the control device 3 is used to control an emission direction of the image light L1 by controlling the deformation degree of the modulation portions 20.

The augmented reality display apparatus 100 provided in the present embodiment changes the deformations of the modulation portions 20 by changing the value of the power voltage, thereby changing a reflection direction of the image light L1, which can correct a chromatic aberration problem caused by primary colors. Different augmented reality display apparatus may have different chromatic aberration degree, the present embodiment is conducive to correct the different chromatic aberration degree by changing the deformation degree of the modulation portions 20.

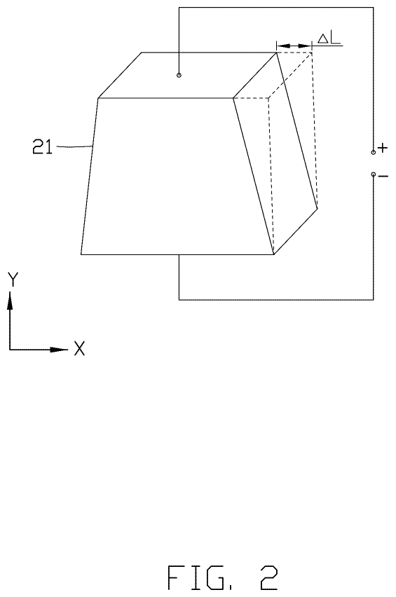

Each of the modulation portion 20 includes a piezoelectric ceramic 21 and a reflecting layer 210 on a surface of the piezoelectric ceramic 21 facing the display device 1. The reflecting layer 210 is used to reflect the image light L1. The piezoelectric ceramic 21 is connected to the control device 3, and the power voltage is used to change the deformation degree of the piezoelectric ceramic 21. As shown in FIG. 2, the piezoelectric ceramic 21 has a mode of d₁₅ (shear piezoelectric strain constant), which uses a shear strain effect of the piezoelectric ceramic 21. When the power voltage is applied to the piezoelectric ceramic 21, an electric field is generated in a second direction Y due to a piezoelectric effect, and the piezoelectric ceramic 21 is subjected to an external voltage in the second direction Y. Due to an inverse piezoelectric effect, the piezoelectric ceramic 21 generates a deformation degree ΔL (that is, a shear deformation degree) in a first direction X under an action of the external voltage. The first direction X and the second direction Y are perpendicular. A direction of the electric field is perpendicular to a deformation direction of the piezoelectric ceramic 21. The deformation degree ΔL changes with the power voltage. The deformation degree ΔL and the power voltage V satisfies:

$$Δ L = {d}_{15} V \qquad ( 1 )$$

In the equation (1), V indicates the power voltage applied to the piezoelectric ceramic 21, and d₁₅ indicates a piezoelectric constant of the piezoelectric ceramic 21. The deformation degree ΔL of the piezoelectric ceramics 21 changes with the mode of the piezoelectric ceramics 21 and the power voltage applied on the piezoelectric ceramics 21. The mode of the piezoelectric ceramic 21 is not limited in d₁₅, the mode of the piezoelectric ceramic 21 can be d₃₃ or d₃₁ in other embodiments.

The display device 1 of the augmented reality display apparatus 100 can use a DLP (Digital Light Processing) technology, a light-emitting diode panel (such as a micro-organic light-emitting diode or a micro light-emitting diode), or a liquid crystal display screen that needs external light source. The display device 1 is not limited.

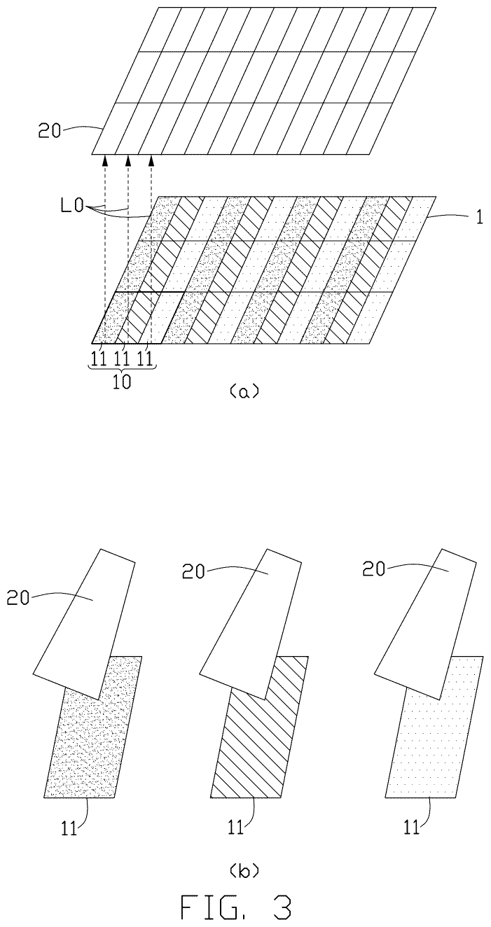

In a first embodiment, as shown in FIG. 1 and FIG. 3, the display device 1 includes a plurality of pixels 10 (see (a) in FIG. 3) arranged in an array. Each of the pixel 10 includes a plurality of sub-pixels 11 used to emit primary lights L0 of different colors. As shown in (b) of FIG. 3, the modulation portions 20 are arranged in an array similarly to the array formed by the pixels, there by the modulation portions 20 and the sub-pixels 11 correspond one-by-one. The primary lights L0 emit simultaneously, each modulation portion 20 is used to change the reflection direction of one primary light L0 from one corresponding sub-pixel 11, and the control device 3 controls the emission directions of the primary lights L0 simultaneously. In this embodiment, each pixel 10 includes three sub-pixels 11 to emit three primary lights L0 of red, green, and blue color. In other embodiments, each pixel 10 may include two sub-pixels 11 or four sub-pixels 11, and adjacent sub-pixels 11 may emit the same or different colored primary light L0.

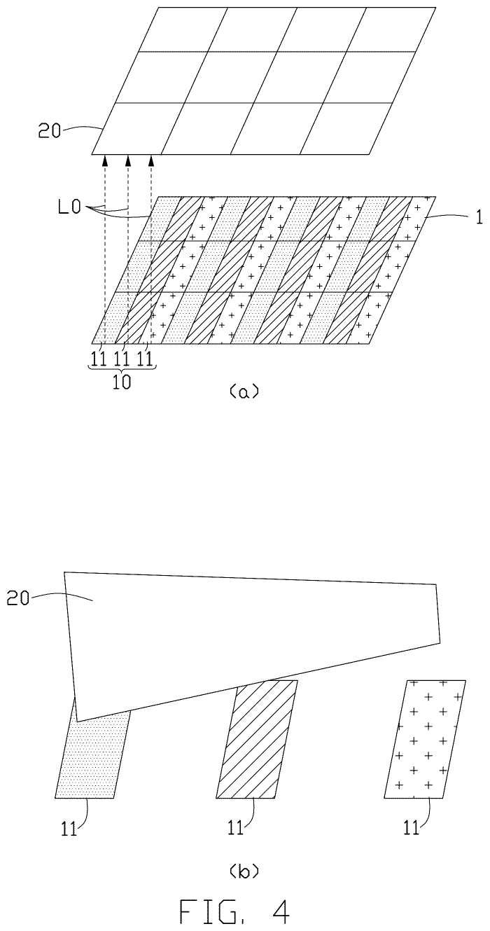

In a second embodiment, as shown in FIG. 1 and FIG. 4, each of the pixel 10 includes a plurality of sub-pixels 11 used to emit primary lights L0 of different colors, and the modulation portions 20 and the pixels 10 correspond one-by-one. As shown in (b) of FIG. 4, the primary lights L0 from a same pixel 10 emits successively, and the modulation portion 20 adjusts the emission directions of the primary lights L0 from the same pixel 10 successively. The augmented reality display apparatus 100 in the second embodiment further reduces a processing difficulty by corresponding each pixel 10 to one modulation portion 20, which is suitable for a situation that there are great amount of pixels 10 and small size of each pixel 10 in the display device 1, thereby can increase an efficiency of chromatic aberration correction and reduce a calculation difficulty of the control device 3.

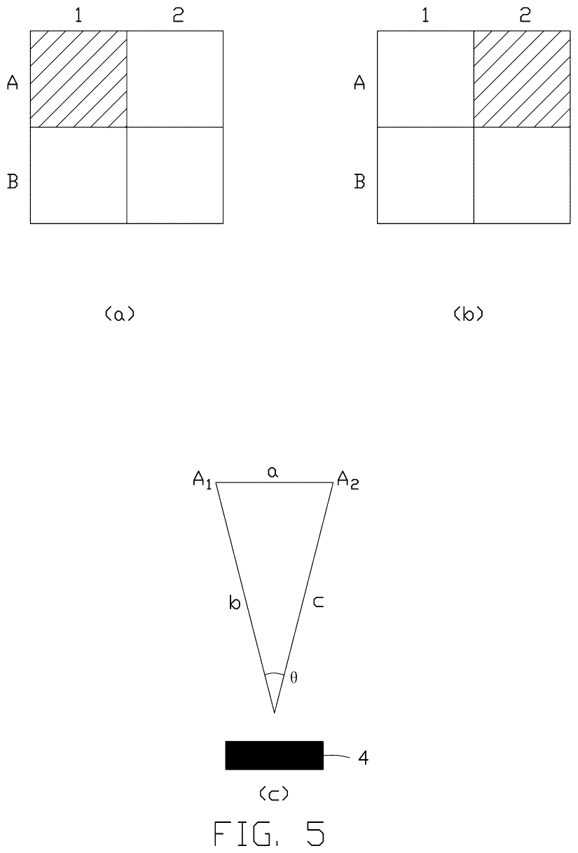

As shown in FIG. 3 and FIG. 5, a chromatic aberration correction process is described as an example in the following. FIG. 5 shows images displayed by the display device 1 having a 2×2 pixel array. The display device 1 intends to show a preset image (see (a) of the FIG. 5) by controlling a pixel A1 to display red image and controlling the pixels A2, A3, and A4 to display black image. The four pixels A1, A2, A3, and A4 are used to emit the primary lights L0, respectively. A color analyzer 4 is used to receive the primary lights L0 from the optical waveguide 2 to capture an actual image (see (b) of the FIG. 5). In the actual image, the pixel A2 displays red image instead of the pixel A1, which indicates an angle deviation of the primary light L0 from the pixel A1 is occurred. Based on positions of the pixel A1 and the pixel A2, a deviation angle θ of the image light L1 can be calculated. The following equation (2) can be generated according to the cosine theorem of triangles:

$$cos θ = \frac{( {c}^{2} + {b}^{2} - {a}^{2} )}{2 b c} \qquad ( 2 )$$

In the equation (2), b indicates a distance from the color analyzer 4 to the pixel A1, and c indicates a distance from the color analyzer 4 to the pixel A2. The a, b, and c are known constants. Based on the equation (2), the control device 3 can calculate the deflection angle θ of the image light L1 and adjust a value of the power voltage applied to the modulation portion 20 to change the direction of the image light L1.

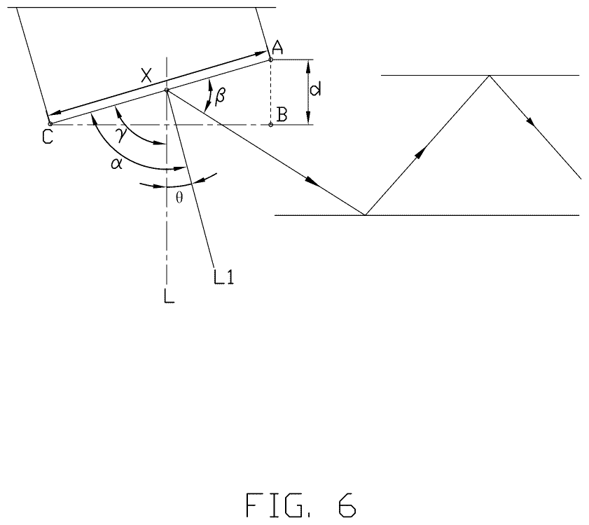

As shown in FIG. 6, α indicates an incident angle of the image light L1 incident on the modulation portion 20, β indicates a diffraction angle of the image light L1 from the modulation portion 20, α and β satisfy the following relationship (3):

$$sin a \pm sin β = \frac{m λ}{( {n}_{d} * d )} \qquad ( 3 )$$

In the equation (3), m indicates a diffraction order, which is related to an aperture formed by the modulation portions 20, λ indicates a wavelength of the image light L1, d indicates a length of AB in the triangle ABC, and n_{d} indicates a refractive index of the modulation portion 20. In the present embodiment, the diffraction order m, the wavelength λ, and the refractive index n_{d} of the modulation portion 20 are constants. An axis L vertical to a line segment BC is defined. When the image light L1 incidents on the modulation portion 20 and the image light L1 reflected by the modulation portion 20 are on a same side of the axis L, the equation (3) is written as:

$$sin a + sin β = \frac{m λ}{( {n}_{d} * d )} ,$$

and when the image light L1 incidents on the modulation portion 20 and the image light L1 reflected by the modulation portion 20 are on different sides of the axis L, the equation (3) is written as:

$$sin a - sin β = \frac{m λ}{( {n}_{d} * d )} .$$

As shown in FIG. 6, inner angles of the triangle ABC satisfied the following relationship (4):

$$sin a = sin ( γ + θ ) \qquad ( 4 )$$

In the equation (4), γ indicates an initial incident angle of the image light L1 without any deviation, α indicates the incident angle when the image light L1 is deviated, that is α=γ+θ.

Based on the sine theorem, a length X of the line segment AC and a length d of the line segment AB in the triangle ABC satisfies the following relationship (5):

$$sin γ = \frac{\sqrt{{x}^{2} - {d}^{2}}}{x} \qquad ( 5 )$$

According to the equation (3) and (4), when the diffraction order m is 1, a relationship (6) is obtained:

$$sin ( γ + θ ) + sin β = \frac{λ}{( {n}_{d} * d )} \qquad ( 6 )$$

The length d of the line segment AB changes (that is, the deformation is occurred) when the control device 3 adjusts the value of the power voltage applied on the modulation portion 20 based on the deflection angle θ. A relationship (7) is obtained according to the equation (1) and (6):

$$sin β = \frac{λ}{{n}_{d} * ( d \pm {d}_{15} V )} - sin ( γ + θ ) \qquad ( 7 )$$

When the modulation portion 20 expands, the equation (7) is written as:

$$sin β = \frac{λ}{{n}_{d} * ( d + {d}_{15} V )} - sin ( γ + θ ) ,$$

and when the modulation portion 20 shrinks, the equation (7) is written as:

$$sin β = \frac{λ}{{n}_{d} * ( d - {d}_{15} V )} - sin ( γ + θ ) .$$

According to the equation (5) and (7), the cosine theorem, the sine theorem, and trigonometric functions, an equation (8) of the diffraction angle β and the power voltage V is generated as:

$$sin β = \frac{λ}{{n}_{d} * ( d \pm {d}_{15} V )} - \frac{( {c}^{2} + {b}^{2} - {a}^{2} ) * \sqrt{{X}^{2} - {d}^{2}}}{2 b c * X} - \frac{d * \sqrt{4 {c}^{2} {b}^{2} - {( {c}^{2} + {b}^{2} - {a}^{2} )}^{2}}}{2 b c * X} \qquad ( 8 )$$

When the modulation portion 20 expands, the equation (7) is written as:

$$sin β = \frac{λ}{{n}_{d} * ( d + {d}_{15} V )} - \frac{( {c}^{2} + {b}^{2} - {a}^{2} ) * \sqrt{{X}^{2} - {d}^{2}}}{2 b * X} - \frac{d * \sqrt{4 {c}^{2} {b}^{2} - {( {c}^{2} + {b}^{2} - {a}^{2} )}^{2}}}{2 b * X} ,$$

and when the modulation portion 20 shrinks, the equation (7) is written as:

$$sin β = \frac{λ}{{n}_{d} * ( d - {d}_{15} V )} - \frac{( {c}^{2} + {b}^{2} - {a}^{2} ) * \sqrt{{X}^{2} - {d}^{2}}}{2 b c * X} - \frac{d * \sqrt{4 {c}^{2} {b}^{2} - {( {c}^{2} + {b}^{2} - {a}^{2} )}^{2}}}{2 bc * X} .$$

The control device 3 is used to control the modulation portion 20 to expand or shrink according to different chromatic aberration condition of the image. When the modulation portion 20 expands, the diffraction angle β decreases as the power voltage V increases. When the modulation portion 20 shrinks, the diffraction angle β increases as the power voltage V increases. The augmented reality display apparatus 100 provided in this embodiment of the disclosure determines a chromatic aberration condition of the images through the control device 3, adjusts the value of the power voltage applied to the modulation portion 20, which can optimize the image displayed by the display device, improve a quality of the image conveniently and quickly, and enhances a user's experience.

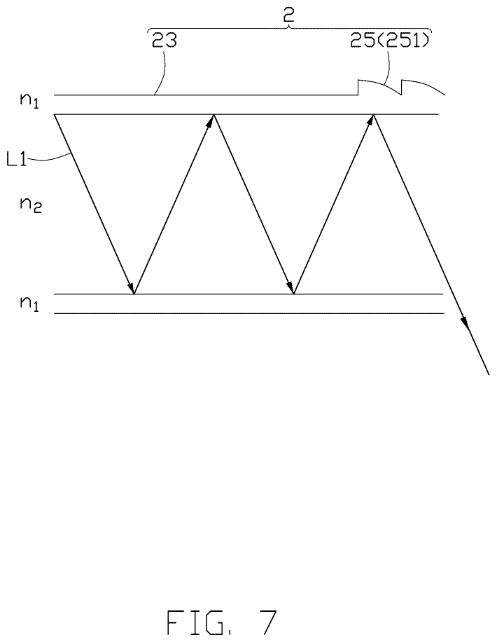

As shown in FIG. 1 and FIG. 7, the optical waveguide 2 includes a total reflection portion 23 used to reflect the image light L1 from the modulation portion 20. The image light L1 undergoes total reflection at the total reflection portion 23. The optical waveguide 2 also includes an outgoing diffraction portion 25 used to receive and reflect the image light L1 from the total reflection portion 23. The image light L1 emitted from the outgoing diffraction portion 25 can forms the images to the human eye. In order to make the image light L1 undergoing the total reflection at the total reflection portion 23, a first medium n1 of the total reflection portion 23 should be greater than a second medium n2 of the total reflection portion 23, and an incident angle of the image light L1 incident on the total reflection portion 23 should be greater than a critical angle. The first medium n1 of the total reflection portion 23 is a lightweight, transparent, and high refractive index glass substrate, generally with a thickness of several millimeters or sub millimeters. The image light L1 advances through back and forth total reflection between the first medium n1 and the second medium n2 on a surface of the glass.

In this embodiment, the outgoing diffraction portion 25 is used to modulate the image light L1 with any incident angle to incident into the human eye perpendicularly. The outgoing diffraction portion 25 includes an exit coupled grating 251 used to receive and vertically emit the image light L1 into the human eye. In other embodiments, the outgoing diffraction portion 25 includes multiple semi-reflective and semi-transparent mirrors, each semi-reflective and semi-transparent mirror is used to reflect a portion of image light L1 out of the optical waveguide 2 into the human eye and transmit the remaining light to a next semi-reflective and semi-transparent mirror, thereby the image light L1 continues to move forward in the optical waveguide 2 until the last semi-transparent and semi-reflective reflects all the remaining image light L1 out of the waveguide 2.

The augmented reality display apparatus 100 provided in the present embodiment can change the deformation degree of the modulation portion 20 by changing the value of the power voltage, thereby changing a reflection direction of the image light L1.

A chromatic aberration adjustment method is also provided in the present embodiment. The chromatic aberration adjustment method can solve the chromatic aberration problem caused by different primary light L0 of different display devices.

The chromatic aberration adjustment method can applied to the augmented reality display apparatuses in any embodiment above.

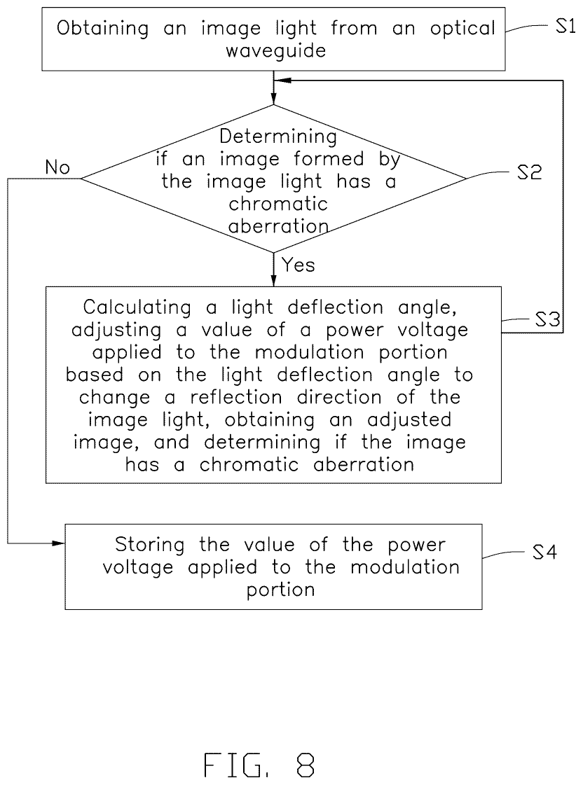

A chromatic aberration adjustment method is also provided in the present disclosure. As shown in FIG. 8, the chromatic aberration adjustment method of an embodiment includes the following steps.

Block S1: obtaining an image light from an optical waveguide.

Block S2: determining if an image formed by the image light has a chromatic aberration.

If there is a chromatic aberration, goes to block S3: calculating a light deflection angle, adjusting a value of a power voltage applied to the modulation portion based on the light deflection angle to change a reflection direction of the image light, obtaining an adjusted image, and determining if the image has a chromatic aberration.

If there is no chromatic aberration, goes to block S4: storing the value of the power voltage applied to the modulation portion.

In the block S1, the color analyzer 4 or a camera with an image processing function is used to receive the image light L1 from the optical waveguide 2 to obtain the image, wherein the color analyzer 4 is also used to record positions of the pixels 10 of the display device 1. The block S2 includes: determining whether there is a deviation between the positions of the pixels 10 in the image obtained by the color analyzer 4 and the positions of the pixels in the display device 1. If the block S2 determines there is a chromatic aberration, the block S3 calculates the deflection angle of the image light L1 and calculates a relationship between the power voltage and the deflection angle according to the trigonometric function, the diffraction grating formula and a type of the modulation portion 20. The chromatic aberration adjustment method applied to the augmented reality display apparatuses 100 in the resent disclosure can achieve the same beneficial effect as the augmented reality display apparatuses 100 described above.

Finally, it should be noted that the above embodiments are only used to illustrate the technical solution of the present disclosure and not to limit the present disclosure. Although the present disclosure has been described in detail with reference to preferred embodiments, one ordinary skill in the art should understand that the technical solution of the present disclosure can be modified or equivalent replaced without departing from the spirit and scope of the technical solution of the present disclosure.

1-10. (canceled)

11. An augmented reality display apparatus, comprising:
a display device for emitting image light;
an optical waveguide comprising a plurality of modulation portions, each of the plurality of modulation portions being configured to receive and reflect the image light, the optical waveguide being configured to receive and guide the image light to human eye; and
a control device electrically connected to the plurality of modulation portions and being configured to provide a power voltage to each of the plurality of modulation portions;
wherein a deformation degree of each of the plurality of modulation portions changes with a value of the power voltage, and the control device is further configured to control a direction of the image light by controlling the deformation degree of the plurality of modulation portions.

12. The augmented reality display apparatus according to claim 11, wherein the display device comprises a plurality of pixels, each of the plurality of pixels comprises a plurality of sub-pixels to emit a plurality of primary lights of different colors simultaneously; and
the plurality of sub-pixels correspond to the plurality of modulation portions one-by-one, each of the plurality of modulation portions is configured to change one of the plurality of primary lights from a corresponding sub-pixel, the control device is configured to control the directions of the plurality of primary lights simultaneously.

13. The augmented reality display apparatus according to claim 11, wherein the display device comprises a plurality of pixels, each of the plurality of pixels comprises a plurality of sub-pixels to emit a plurality of primary lights of different colors successively; and
the plurality of pixels correspond to the plurality of modulation portions one-by-one, each of the plurality of modulation portions is configured to change one of the plurality of primary lights from a corresponding pixel, the control device is configured to control the directions of the plurality of primary lights successively.

14. The augmented reality display apparatus according to claim 11, wherein each of the plurality of pixels comprises three sub-pixels to emit three primary lights of different colors.

15. The augmented reality display apparatus according to claim 11, wherein each of the plurality of modulation portions comprises a piezoelectric ceramic and a reflecting layer on a surface of the piezoelectric ceramic facing the display device.

16. The augmented reality display apparatus according to claim 15, wherein the reflecting layer is configured to reflect the image light, the piezoelectric ceramic is connected to the control device, and the control device is further configured to change the deformation degree of the piezoelectric ceramic by changing the value of the power voltage.

17. The augmented reality display apparatus according to claim 15, wherein each of the plurality of pixels comprises three sub-pixels to emit three primary lights of different colors.

18. The augmented reality display apparatus according to claim 11, wherein the optical waveguide comprises a total reflex portion configured for total reflection of the image light from the plurality of modulation portions.

19. The augmented reality display apparatus according to claim 18, wherein the waveguide further comprises an outgoing diffraction portion configured to receive and reflect the image light after been total reflected by the total reflex portion, and the image light exit from the outgoing diffraction portion forms image to the human eye.

20. The augmented reality display apparatus according to claim 11, wherein the control device is further configured to control the plurality of modulation portions to expand or contract according to a chromatic aberration of an image formed by the image light.

21. The augmented reality display apparatus according to claim 20, wherein a diffraction angle of the image light exit from the plurality of modulation portions deceases as the value of the power voltage increases when the plurality of modulation portions are controlled to expand.

22. The augmented reality display apparatus according to claim 21, wherein a diffraction angle of the image light exit from the plurality of modulation portions increases as the value of the power voltage increases when the plurality of modulation portions are controlled to shrink.

23. The augmented reality display apparatus according to claim 11, wherein the image light from the waveguide incident into the human eye vertically.

24. A chromatic aberration adjustment method configured to correct a chromatic aberration of an image and applied to an augmented reality display device, comprising:
obtaining image light from an optical waveguide;
determining if an image formed by the image light has a chromatic aberration;
if there is a chromatic aberration, calculating a light deflection angle, adjusting a value of a power voltage applied to the modulation portion based on the light deflection angle to change a reflection direction of the image light, obtaining an adjusted image, and determining if the adjusted image has a chromatic aberration; and
if there is no chromatic aberration, storing the value of the power voltage applied to a plurality of modulation portions.

25. The chromatic aberration adjustment method according to claim 24, wherein the obtaining image light from an optical waveguide comprises:
obtaining the image light by a color analyzer and saving a position information of each of a plurality of pixels of a display device.

26. The chromatic aberration adjustment method according to claim 25, wherein the determining if an image formed by the image light has a chromatic aberration comprises:
determining whether a deviation is between a position of each of the plurality of pixels in the image and the position of each of the plurality of pixels in the display device.
